(19) United States
(12) Patent Application Publication
(10) Pub. No.: US 2004/0032876 A1
(43) Pub. Date: Feb. 19, 2004

(54) Selection of transmission channels

(76) Inventors: Ajay Garg, Portland, OR (US); Ulhas S. Warrier, Beaverton, OR (US)

Correspondence Address: FISH & RICHARDSON, PC, 12390 EL CAMINO REAL, SAN DIEGO, CA, 92130-2081, US

(21) Appl. No.: 10/223,873

(22) Filed: Aug. 19, 2002

(51) Int. Cl. H04B 7/212; H04L 12/66

(52) U.S. Cl. 370/443; 370/352

(57) ABSTRACT

A method of transmitting data, includes providing selectable data channels through a data forwarding device, at least two of the selectable data channels having different transmission characteristics, reserving one of the selectable data channels based on a received channel request message, and transmitting a data packet through the reserved data channel.

### TECHNICAL FIELD

This application relates to selection of data transmission channels.

### BACKGROUND

A computer user located in a residence or business who wants to access the resources of a wide area network (WAN), such as the Internet, may subscribe to a broadband service provided by an Internet Service Provider (ISP) or a Broadband Service Provider (BSP). Broadband service refers to relatively high-speed data transmissions through a communications link (e.g., a cable line, phone line or wireless medium) between an ISP/BSP computer and a modem at the residence or business. The data transmissions between the ISP/BSP computer and the modem may be multiplexed to provide multiple data channels through the communication link. In this case, each data channel may be characterized by a different Quality of Service (QOS) level. QOS level refers to the transmission characteristics of each data channel, i.e., bandwidth, error rate, latency and other characteristics.

At the business or residence the modem may be connected to a Local Area Network (LAN), i.e., a network of interconnected “client” or “network” devices that are able to communicate with each other using a common protocol, such as an Internet Protocol (IP). Typically, the LAN includes a gateway (or router) device connected between the client devices and the modem. The gateway device operates as a data forwarding device, i.e., determining which data packets received from a client device or from a device connected to the WAN that are to be forwarded through the gateway device.

The functions of the broadband modem are sometimes implemented in the gateway device.

A LAN installed at a home or residence is sometimes referred to as a Small Office or Home Office (SOHO) network.

### DESCRIPTION OF THE DRAWINGS

FIG. 1 is a block diagram of a data transmission system.

FIG. 2 is a block diagram depicting various application components for providing selectable data channels.

FIG. 3 is a block diagram of computer hardware on which the application components of FIG. 2 may be implemented.

### DESCRIPTION

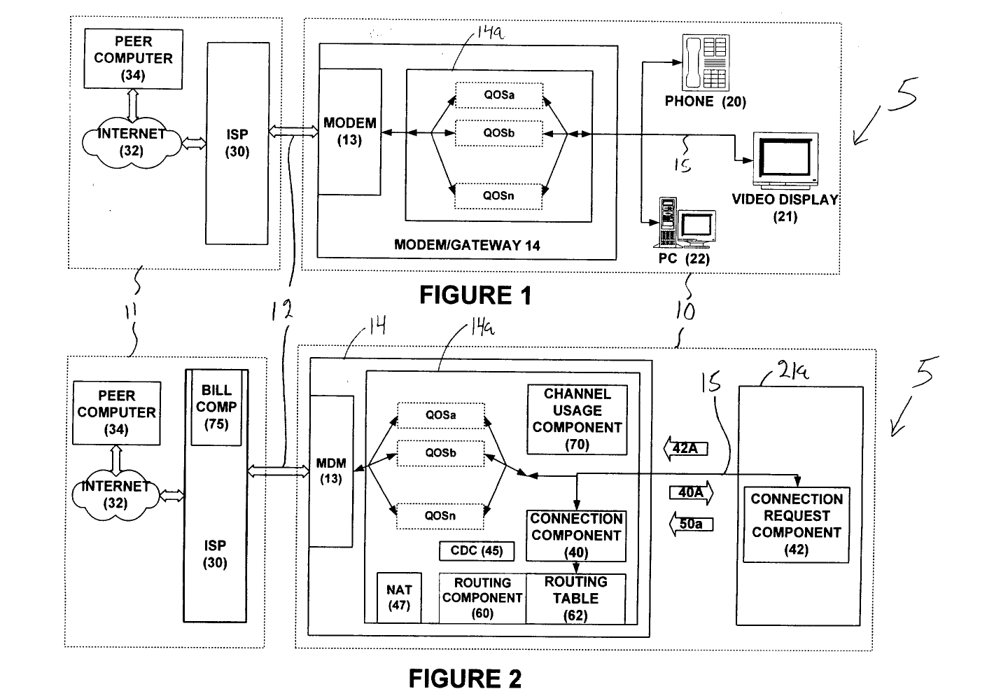

Referring to FIGS. 1 and 2, a data transmission system 5 includes a local area network 10 (LAN 10) connected by a communications link 12 to a wide area network 11 (WAN 11). LAN 10 includes client devices 20-22, each connected to a gateway device 14 by a network bus 15. In this example, WAN 11 includes an ISP computer connected to Internet 32 and a peer computer 34, also in this example, gateway device 14 includes a modem 13 that is connected to communications link 12. ISP computer 30 and modem 13 are capable of multiplexing multiple data channels, QOSa-QOSn, through communication link 12. Each data channel, QOSa-QOSn, may have a different QOS level.

During operation of system 5, a gateway application 14a, executing on gateway 14, determines the available data channels between ISP computer 30 and modem 13, and the transmission characteristics of those available data channels. Gateway application 14a then sends a channel availability message 40a to the client devices 20-22. Channel availability message 40a indicates the available data channels, QOSa-QOSn, through communications link 12 and transmission characteristics corresponding to each available channel. A user of a client device (“a subscriber”) may then select among the available data channels by executing a client application on one of client devices 20-22, i.e., the client application sends a channel request message 42a to the gateway application 14a to reserve a specific data channel for subsequent transmissions from the client device through gateway 14. If the data channel requested is available, the data channel number, e.g., QOSa-QOSn, is reserved for the requesting client application and/or client device. Thereafter, data transmitted from the client application and addressed to a device on the WAN 11, is forwarded through the corresponding data channel on communications link 12. In an embodiment, at least two data channels are available, each data channel having a different data transmission characteristic, for example, a different bandwidth capacity, error rate and/or latency.

In general, a subscriber to a conventional broadband service selects, and pays for, a single data channel having a “guaranteed” QOS level. Guaranteed QOS level refers to a QOS level data channel that the broadband service provider attempts to provide during use of the data channel. Typically, the higher the QOS level selected by the subscriber, the higher the subscription fee. A LAN may include several client devices, each executing one or more applications that require the transmission of data through gateway 14 (hereafter referred to as data transfer sessions). Each data transfer session may require a different QOS level to ensure data is transmitted fast enough, for example, to ensure a satisfactory performance to a user of the client application. However, when subscribing to a conventional broadband service a subscriber normally must subscribe to the highest QOS level channel required by the highest bandwidth application that may be executed by a client device connected to the LAN. This way of providing and subscribing to a specific QOS level data channel often results in “wasted” bandwidth, for example, when the application requiring the highest bandwidth is not being executed in the LAN. Moreover, as described previously, the subscriber usually pays for a guaranteed QOS level even when the actual transmission characteristics of the channel are less than the “guaranteed” level. Also, since more than one application may be executing on the network at the same time, each application may compete for bandwidth on the single channel provided, which makes it even more likely that the QOS level guarantee is not achieved.

In an embodiment, system 5 includes a gateway application, executing on a gateway device, that signals the availability of at least two data channels having different QOS levels through the gateway device. The subscriber, executing a client application on a client device, may then dynamically select, and pay for, a QOS level channel on an “as-needed” basis. This way of providing selectable QOS level data channels reduces the overall cost to the subscriber and also reduces the potential for paying for data channel characteristics that are not required. Moreover, this way of providing selectable QOS level channels allows an application executing on a client device to request an available data channel for a data transfer session without requiring other operating system layers executing on the same client device to participate in establishing that data transfer session. That is, the operating system on a client device does not require modification to support an application requesting and establishing a data transfer session.

As an example of the use of system 5, an Internet browser application (not shown) executing on personal computer 22 will typically require a relatively low bandwidth data channel, while a streaming-video (SV) application executing on video display device 21 will typically require a relatively high bandwidth data channel. In this case, the SV application may send a channel request message to gateway application 14a for a data channel having a relatively high bandwidth to transmit data. Conversely, the browser application executing on PC 22 may send a channel request message for a data channel having a relatively low bandwidth capacity, or simply transmit data through a “default” data channel (sometimes referred to as a channel executing a “best effort” protocol). A relatively high bandwidth channel is important for the transmission of video data and multimedia data.

In some examples, gateway application 14a signals the availability of at least one relatively low bandwidth data channel that has a relatively low subscriber fee, and at least one relatively high bandwidth data channel that has a relatively higher subscriber fee. The subscriber may be charged for the use of each data channel selected based on the amount of time that each data channel is reserved and/or used by the subscriber.

In an embodiment, gateway application 14a includes a channel determination component (CDC) 45 that when executed by gateway device 14, communicates with ISP computer 30 and/or modem 13 to determine the available data transmission channels between ISP computer 30 and modem 13. In an alternate embodiment, channel determination component 45 may be executed on a client device to determine the available data transmission channels between ISP computer 30 and modem 13.

Gateway application 14a and network application 21a include various functional components, e.g., sets of executable instructions, that when executed, perform specific functions of the respective applications 14a and 21a. For example, gateway application 14a includes a connection component 40 (CC 40) that makes available channel availability information that relates to the availability of data channels QOSa-QOSn. CC 40 may make the channel availability information available to the client devices in a variety of ways, for example, by broadcasting the channel availability information to client devices on network bus 15 by sending a data channel availability message 40a on network bus 15, or by sending data channel availability message in response to a channel availability request sent by a client application, such as CR 42, or by storing data that represents the available channels in a data file (such a web-page) that is accessible (“retrievable”) by a client application executing on a LAN 10 client device. Data channel availability information may include the minimum transmission characteristics for each available data channel, QOSa-QOSn.

Client application 21a includes a connection request component 42 (CR 42) that receives the data channel availability information signal 40a sent by CC 40 (or retrieves the information from a data file that holds the channel availability information). Based in part on the received data channel availability information signal, CR 42 determines which of the available data channels to request for subsequent data transmissions between client application 21a and a device connected to WAN 11. As an example, in order to request channel QOSa for subsequent data transmissions between client application 21a and a peer computer 34 connected to Internet 32, CR 42 sends a channel request 42a that includes a specific data channel number, e.g., QOSa. Channel request 42a may also include data transfer session information, i.e., a peer IP address corresponding to peer computer 34, a client IP address corresponding to client device 21 and a port number corresponding to client application 21a. The data session information is subsequently used by CC 40 to determine which packets received are to be transmitted through which data channel QOSa-QOSn, as will be explained.

When CC 40 receives the QOS channel request 42a from CR 42, CC 40 stores a data channel reservation in an entry of a routing table 62. Routing table 62 is used by CC 40 to map an entry for each data channel reservation. Each entry in routing table 62 includes the reserved data channel number and the data session information: e.g., the peer IP address, the client device port number and the client IP address. Gateway application 14a includes a routing component 60 (RC 60) that reads (“lookup”) data channel entries from routing table 62. During operation of system 5, for each data packet 50a received from network bus 15, RC 60 determines the client IP address, port number and peer IP address corresponding to the received data packet. The determined IP addresses and/or port number are used by RC 60 to lookup a data channel reservation entry in routing table 62 corresponding to an available data channel for transmitting a received data packet. If a data channel reservation is mapped for a received data packet, RC 60 transmits the data packet through that data channel to peer computer 34. If routing table 62 does not contain a data channel reservation corresponding to a received data packet, a default data channel may be used to transmit the data packet (sometimes referred to as a “best effort” scheme or data channel). Gateway application 14a may include a Network Address Translation (NAT) component 47 that translates client IP addresses to Internet routable IP addresses (provided by ISP computer 30, for example) for data packets received from a client device that are to be forwarded through communications link 12. In an embodiment, NAT component 47 is used to generate an IP address that corresponds to a data transmission channel, i.e., generating an IP address that is usable by ISP computer 30 to determine a specific data transmission channel for transmitting data packets. In this case, gateway application 14a would perform the NAT function after the routing component 60 had determined whether a data packet corresponded to a reserved data channel.

Typical gateway devices, such as gateway device 14, operate fast enough so that data packets received are forwarded without being queued. However, in an alternate embodiment, gateway device 14 may include one or more queues for storing and/or prioritizing data packets to be forwarded through gateway 14. In some examples, priority based QoS mechanisms are applied to data transmissions for a data channel.

In an embodiment, ISP computer 30 may send one or more application components on communications link 12 to gateway device 14 and/or a client device 20-22. In this case, the application components may include a channel determination component (CDC) component 45 that is used to determine the availability and characteristics of each available data transmission channel through communications link 12. Alternatively, ISP computer 30 may transfer a data file to gateway device 14 and/or a client device 20-22, the data file including data that indicates available data transmission channels and their corresponding transmission characteristics, for example.

CR 42 may be implemented in a variety of ways. For example, CR 42 may be included as part of a client application, such as client application 21a (see FIG. 2). Or CR 42 component may be implemented as a separate executable “socket interceptor module”, such as a Winsock Layered Service Provider (LSP) module that, when executed, intercepts data received by a client device, and data sent by a client application executing on that client device. As an example, a Winsock LSP module executing on network device 21 detects each attempt by network application 21a to initiate communication with another computer, such as peer computer 34. The Winsock LSP module captures the communication information from the network application, such as the peer IP address of peer computer 34 and the port number of the client application. The Winsock LSP module then performs the functions of the CR 42 component, i.e., sending a data channel request to CC 40 that includes the captured communication information from the network application.

In some examples, CC 40 sends a confirmation or a denial message in response to a received data channel request 42a from CR 42. In response to a received denial message to a data channel request from CC 40, CR 42 may send an additional channel request message for the same data channel or for a different data channel.

During operation of system 5, a data channel may be reserved by a client application and subsequently released by sending a data channel release request to CC 40. As data channels are reserved and/or released by a client application, CC 40 may send updated data channel availability information on the LAN network 10.

Messages sent between gateway 14 and network devices 20-22 may be based on a Universal Plug and Play (UPnP™) protocol. For example, gateway application component CC 40 may include a data channel service and/or device to provide data channel information to network devices 20-22. Similarly, connection request component 42 may send a UPnP™ inquiry message to “discover” information about other services and/or devices available on LAN network 10 (such as gateway 14). In this case, CR 42 may send a UPnP™ inquiry message on network bus 15 to CC 40 in order to discover the availability of a service including data channels through gateway 14.

In some examples, gateway application 14a includes a channel usage component 70 that stores (or forwards to ISP computer 30) data channel usage information based on the usage of each data channel by a client device 20-22 (i.e., client applications executing on those client devices). The data channel usage information may be requested (and subsequently retrieved) by a billing application 75 executing on ISP computer 30. Billing application 75 may also produce subscriber bills based on the channel usage information of a subscriber on LAN 10.

Gateway application 14a may interpret received data packets and informational signals based on one or more functional layers of an Open Systems Interconnect (OSI) protocol. For example, gateway application 14a may interpret received data packets using the network layer of OSI.

Communications link 12 may be implemented as a communications medium that is capable of transmitting broadband signals, for example, a telephone line, a cable line, a satellite connection or a wireless connection. In some examples, the communications link 12 may be implemented as multiple physical lines, for example, two or more phone lines.

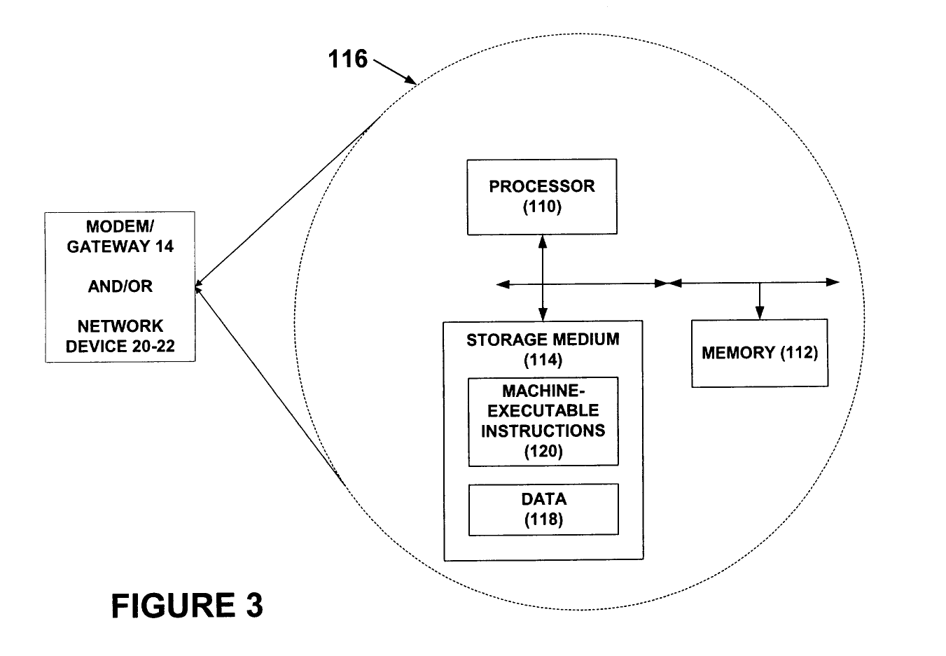

Referring to FIG. 3, gateway 14 and/or client devices 20-22 may be implemented on a processor 110, a memory 112, and a storage medium 114 (see view 116). Storage medium 114 stores data 118 for available data transmission channels, data channel requests and/or data channel usage, for example. Storage medium 114 also stores machine-executable instructions 120 that are executed by processor 110 out of memory 112 to perform gateway application 14a and/or client device application 21a.

Applications 14a and 21a are not limited to use with the hardware and software of FIG. 3. They may find applicability in any computing or processing environment. Applications 14a and 21a may be implemented in hardware, software, or a combination of the two. Applications 14a and 21a may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform applications 14a and 21a and to generate output information.

Each computer program may be stored on a storage medium/article (e.g., CD-ROM, hard disk, or magnetic diskette) that is readable by a general or special purpose programmable computer for configuring and operating the computer when the storage medium or device is read by the computer to perform applications 14a and 21a. Applications 14a and 21a may also be implemented as a machine-readable storage medium, to store instructions, that, when executed cause a machine to operate in accordance with application 14a and 21a.

The invention is not limited to the specific embodiments described above. For example, we described a gateway application and a client application being executed on separate devices. However, both applications could be executed on a single device, for example a computer which connects the LAN network 10 to the WAN network 11.

Other embodiments not described herein are also within the scope of the following claims.

What is claimed is:

1. A method of transmitting data, comprising:
providing selectable data channels through a data forwarding device, at least two of the selectable data channels having different transmission characteristics;
reserving one of the selectable data channels based on a received channel request message; and
transmitting a data packet through the reserved data channel.

2. The method of claim 1, further comprising:
determining the availability of data transmission channels through a communications link connected to the data forwarding device.

3. The method of claim 2, wherein providing further comprises:
sending a data channel availability message to a first network device prior to receiving the channel request message.

4. The method of claim 2, wherein providing further comprises:
responding to a channel availability inquiry message sent by a first network device prior to receiving the channel request message.

5. The method of claim 2, wherein providing further comprises:
storing data that represents data channel availability information in a data file, the data file accessible to a first network device.

6. The method of claim 3, wherein sending further comprises:
sending the data channel availability message on a first network bus, the data forwarding device and the first network device connected to the first network bus.

7. The method of claim 3, wherein at least two of the selectable data channels have different transmission characteristics.

8. The method of claim 7, wherein at least one of the data channel request message and the data channel availability message comprises a UPnP™ protocol message.

9. The method of claim 3, wherein providing selectable data channels further comprises:
providing data channels through a modem device connected to a communications link.

10. The method of claim 3, wherein the data channel request message includes at least one of a peer internet protocol (IP) address corresponding to a second network device, a port number of an application executable on the first network device and a source internet protocol (IP) address corresponding to the first network device, the method further comprises:
storing at least one of the destination IP address, the port number and the source IP address corresponding to the reserved data channel.

11. The method of claim 10, wherein transmitting further comprises:
determining the reserved data channel for transmitting a received data packet based on at least one of the stored peer IP address, port number and source IP address.

12. The method of 3, wherein transmitting further comprises:
associating a data channel IP address with the received data packet before transmitting the data packet through the communications link.

13. The method of claim 2, wherein determining further comprises:
receiving a data file through the communications link; and
determining from the data file the available data transmission channels through the communications link.

14. The method of claim 2, wherein determining further comprises:
receiving an executable file through the communications link; and
executing the executable file on at least one of the data forwarding device and the first network device to determine the available data transmission channels through the communications link.

15. An article comprising a storage medium having stored thereon instructions that when executed by a machine results in the following:
provide selectable data channels through a data forwarding device, at least two of the selectable data channels having different transmission characteristics;
reserve one of the selectable data channels based on a received channel request message; and
transmit a data packet through the reserved data channel.

16. The article of claim 15, further comprising instructions that when executed by a machine results in the following:
determine the availability of data transmission channels through a communications link connected to the data forwarding device.

17. The article of claim 16, further comprising instructions that when executed by a machine results in the following:
send a data channel availability message to a first network device prior to receiving the channel request message.

18. The article of claim 16, further comprising instructions that when executed by a machine results in the following:
respond to a channel availability inquiry message sent by a first network device prior to receiving the channel request message.

19. The article of claim 16, further comprising instructions that when executed by a machine results in the following:
store data in a data file that represents data channel availability information, the data file accessible to a first network device.

20. The article of claim 17, further comprising instructions that when executed by a machine results in the following:
send the data channel availability message on a first network bus, the data forwarding device and the first network device connected to the first network bus.

21. The article of claim 17, wherein at least two of the selectable data channels have different transmission characteristics.

22. The article of claim 21, wherein at least one of the data channel request message and the data channel availability message comprises a UPnP™ protocol message.

23. The article of claim 17, wherein the data channel request message includes at least one of a peer internet protocol (IP) address corresponding to a second network device, a port number of an application executable on the first network device and a source internet protocol (IP) address corresponding to the first network device.

24. The article of claim 23, further comprising instructions that when executed by a machine results in the following:
store at least one of the destination IP address, the port number and the source IP address corresponding to the reserved data channel.

25. The article of claim 24, further comprising instructions that when executed by a machine results in the following:
determine the reserved data channel for transmitting a received data packet based on at least one of the stored peer IP address, port number and source IP address.

26. A system for transmitting data comprising:
a data forwarding device connected between a communications link and at least one client network device, the data forwarding device to determine available transmission channels through the communications link and provide selectable data channel availability information to the client network device, the selectable data channel availability information based upon the determined available transmission channels.

27. The system of claim 26 wherein the data forwarding device further comprises:
a memory that stores executable instructions; and
a processor that executes the instructions to:
reserve an available data channel based on a received channel request message.

28. The system of claim 27 wherein the processor executes instructions to store data channel availability information in a storage area accessible to the client network device.

29. The system of claim 28 further comprises:
a modem device connected between the data forwarding device and the communications link.
